(19) United States
(12) Patent Application Publication
(10) Pub. No.: US 2009/0013980 A1
(43) Pub. Date: Jan. 15, 2009

(54) TWO CYCLE ENGINE

(76) Inventors: Ken Takachi, Osaka-shi (JP); Shuji Ogai, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/629,172

(22) PCT Filed: Jul. 4, 2006
(86) PCT No.: PCT/JP2006/313298

§ 371 Date: Sep. 18, 2008

(30) Foreign Application Priority Data
Jul. 5, 2005 (JP) 2005-196862

(51) Int. Cl. F02B 25/00

(52) U.S. Cl. 123/65 R

(57) ABSTRACT

Size reduction and pollution reduction are promoted in a two cycle engine. A two cycle engine includes: a cylinder which contains a piston so as to allow reciprocating movement of the piston; a scavenging gas reserving chamber which covers a lower opening of the cylinder so as to seal the lower opening; an intake portion which is provided in the scavenging gas reserving chamber; a scavenging passage which provides communication between the scavenging gas reserving chamber and the cylinder; a connecting rod which is connected to the piston and passes through the scavenging gas reserving chamber; a crank mechanism which allows linear reciprocating movement of the connecting rod; and a sealing portion which is provided in an insertion hole in the scavenging gas reserving chamber through which the connecting rod passes and which allows linear reciprocating movement of the connecting rod but seals the scavenging gas reserving chamber. The two cycle engine may have a structure in which the intake portion has a structure for drawing outside air into the scavenging gas reserving chamber and in which a spraying mechanism for spraying fuel is provided in the cylinder head.

### BACKGROUND OF THE INVENTION

1. Field of the Invention

The present invention relates to a two cycle engine.

2. Description of the Related Art

There is known a two cycle engine 100 having a structure, for example, shown in FIG. 13. Specifically, a scavenging passage 103 extending from the upper portion of a crankcase 102 is formed inside the sidewall of a cylinder 101. Furthermore, the scavenging passage 103 is in communication with a scavenging port 104 in the cylinder 101. A gas mixture is supplied from an intake port (not shown) into the crankcase 102, and the downward movement of a piston 105 allows the gas mixture to be supplied from the scavenging port 104 into the cylinder 101 via the scavenging passage 103. Such a two cycle engine 100 is utilized as a small engine for lawn mowers and the like.

[Patent Document 1] Japanese Patent Laid-Open Publication No. 2000-179346

However, in such a two cycle engine 100, the cylinder 101 is in communication with the crankcase 102, and a gas mixture containing engine oil is pushed out of the crankcase 102 by the downward movement of the piston 105 and flows from the scavenging port 104 into the cylinder 101. Thus, the engine oil is combusted with fuel. Hence, the engine oil must be added regularly, and it is uneconomical. Furthermore, white smoke and soot are generated by the combustion of the engine oil, thereby causing environmental problems.

Moreover, the scavenging port 104 and an exhaust port 106 of the cylinder 101 are opened and closed in response to the movement of the piston 105 to thereby replace the gas mixture. However, since the scavenging port 104 and the exhaust port 106 can be opened simultaneously at a certain timing, a part of scavenging gas can be discharged together with exhaust gas into the atmosphere from the exhaust port 106 without being combusted. This also increases the load on natural environment, and thus a problem arises in terms of the protection of natural environment.

### SUMMARY OF THE INVENTION

A two cycle engine according to the present invention comprises: a cylinder which contains a piston so as to allow reciprocating movement of the piston; a scavenging gas reserving chamber which covers a lower opening of the cylinder so as to seal the lower opening; an intake portion which is provided in the scavenging gas reserving chamber; a scavenging passage which provides communication between the scavenging gas reserving chamber and the cylinder; a connecting rod which is connected to the piston and passes through the scavenging gas reserving chamber; a crank mechanism for linearly reciprocating the connecting rod; and a sealing portion which is provided in an insertion hole in the scavenging gas reserving chamber through which the connecting rod passes, the sealing portion allowing linear reciprocating movement of the connecting rod but sealing the scavenging gas reserving chamber.

Furthermore, the two cycle engine may have a structure in which the intake portion has a structure for drawing outside air into the scavenging gas reserving chamber and in which a spraying mechanism for spraying fuel is provided in a cylinder head.

The two cycle engine is provided with: the crank mechanism for linearly reciprocating the connecting rod; and the sealing portion which is provided in the insertion hole in the scavenging gas reserving chamber through which the connecting rod passes, the sealing portion allowing linear reciprocating movement of the connecting rod but sealing the scavenging gas reserving chamber. Therefore, engine oil supplied to the crank mechanism does not flow into the scavenging gas reserving chamber, and thus a fluid flowing from the scavenging port into the cylinder through the scavenging passage does not contain the engine oil. In this manner, a decrease in the amount of the engine oil in the crank mechanism can be suppressed, and thus it is economical. Furthermore, since the engine oil is not combusted with fuel, white smoke and soot caused by the engine oil are not generated.

In addition to this, consider the case where the two cycle engine has the structure in which the intake portion has the structure for drawing outside air into the scavenging gas reserving chamber and in which the spraying mechanism for spraying fuel is provided in the cylinder head. In this case, fuel is not contained in scavenging gas. Therefore, even when a part of the scavenging gas is discharged together with exhaust gas into the atmosphere from an exhaust port, uncombusted fuel is prevented from being discharged into the atmosphere.

Furthermore, since the connecting rod reciprocates linearly in the two cycle engine of the present invention, the stroke length and the compression ratio can be easily increased. In addition to this, the thermal efficiency can be significantly improved by combining with a supercharging device in accordance with need. Moreover, since the stroke length and the compression ratio can be increased, for example, biomass fuel (such as methanol, ethanol, and methane gas) having a high octane value can be efficiently combusted.

### BRIEF DESCRIPTION OF THE DRAWINGS

FIG. 1 is a vertical cross-sectional front view illustrating a two cycle engine according to an embodiment of the present invention;

FIG. 2 is a vertical cross-sectional side view illustrating the structure of a crank mechanism;

FIG. 3 is a schematic view of the crank mechanism;

FIG. 4 is a vertical cross-sectional front view illustrating a two cycle engine according to another embodiment of the present invention;

FIG. 5 is a vertical cross-sectional front view illustrating a two cycle engine according to another embodiment of the present invention;

FIG. 6A is a vertical cross-sectional front view illustrating a two cycle engine according to another embodiment of the present invention;

FIG. 6B is a vertical cross-sectional side view of the two cycle engine shown in FIG. 6A;

FIG. 7A is a cross-sectional view of the sealing structure of a scavenging gas reserving chamber;

FIG. 7B is an enlarged cross-sectional view of the sealing structure of the scavenging gas reserving chamber;

FIG. 7C is an enlarged cross-sectional view of a modified example of the sealing structure of the scavenging gas reserving chamber;

FIG. 7D is an enlarged cross-sectional view of a modified example of the sealing structure of the scavenging gas reserving chamber;

FIG. 8A is a perspective view of a rod sealing ring;

FIG. 8B is a plan view of overlapped opening ends of the rod sealing ring;

FIG. 8C is a side view of the overlapped opening ends of the rod sealing ring;

FIG. 9A is an enlarged cross-sectional view of another modified example of the sealing structure of the scavenging gas reserving chamber;

FIG. 9B is an enlarged cross-sectional view of another modified example of the sealing structure of the scavenging gas reserving chamber;

FIG. 10A is a vertical cross-sectional front view illustrating a two cycle engine according to another embodiment of the present invention;

FIG. 10B is a vertical cross-sectional side view of the two cycle engine shown in FIG. 10A;

FIG. 11A is a horizontal cross-sectional view of a cylinder liner;

FIG. 11B is a vertical cross-sectional view of the cylinder liner;

FIG. 12 is a vertical cross-sectional front view illustrating a two cycle diesel engine according to an embodiment of the present invention; and

FIG. 13 is a view illustrating a conventional two cycle engine.

### DETAILED DESCRIPTION OF THE PREFERRED EMBODIMENTS

Hereinafter, a two cycle engine according to an embodiment of the present invention will be described with reference to the drawings. In the drawings, members and portions having the same action are designated by the same reference characters.

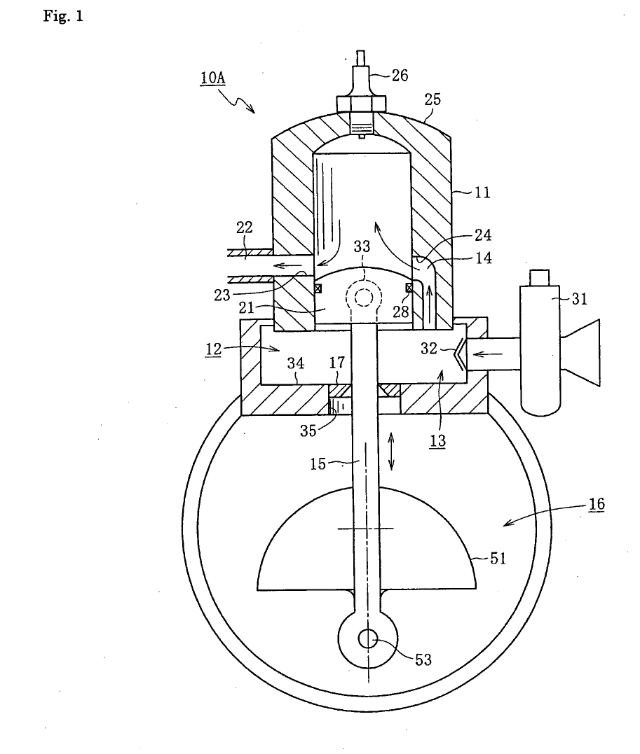

As shown in FIG. 1, a two cycle engine 10A is provided with a cylinder 11, a scavenging gas reserving chamber 12, an intake portion 13, a scavenging passage 14, a connecting rod 15, a crank mechanism 16, and a sealing portion 17.

The cylinder 11 contains a piston 21 so as to allow reciprocating movement of the piston 21. In this embodiment, the cylinder 11 has an exhaust port 23 which is in communication with an exhaust passage 22 and a scavenging port 24 which is in communication with the scavenging passage 14. Each of the exhaust port 23 and the scavenging port 24 is formed in the inner peripheral surface of the cylinder 11 and is located in a position within the reciprocating range of the piston 21. In the cylinder 11, the exhaust port 23 opens at a position higher than the position of the scavenging port 24. Furthermore, a spark plug 26 is mounted in a cylinder head 25. The scavenging gas reserving chamber 12 is provided below the cylinder 11.

The scavenging gas reserving chamber 12 covers a lower opening 27 of the cylinder 11 to seal the lower opening 27. The lower surface of the piston 21 contained in the cylinder 11 is exposed in the scavenging gas reserving chamber 12. The intake portion 13 is provided in the scavenging gas reserving chamber 12. In this embodiment, the intake portion 13 is provided with a carburetor 31, whereby a gas mixture mixed with fuel is drawn as scavenging gas. Furthermore, a reed valve 32 is mounted in the intake portion 13. The reed valve 32 is opened when the pressure of the scavenging gas in the scavenging gas reserving chamber 12 becomes lower than a predetermined pressure, whereby the scavenging gas is drawn into the scavenging gas reserving chamber 12. In this manner, an appropriate amount of the gas mixture is drawn at an appropriate time. Furthermore, the scavenging passage 14 provides communication between the scavenging gas reserving chamber 12 and the cylinder 11 and opens at the abovementioned scavenging port 24 on the cylinder 11 side.

The connecting rod 15 is connected to the piston 21, extends vertically downward from a connecting portion 33 of the piston 21, passes through the scavenging gas reserving chamber 12, and is then connected to the crank mechanism 16 provided below the scavenging gas reserving chamber 12, whereby the connecting rod 15 is allowed to reciprocate linearly. The specific structure of the crank mechanism 16 will be described later. An insertion hole 35 through which the connecting rod 15 passes is formed in a bottom portion 34 of the scavenging gas reserving chamber 12. In the insertion hole 35, the sealing portion 17 is provided which allows linear reciprocating movement of the connecting rod 15 but seals the scavenging gas reserving chamber 12.

Next, a description is given of the crank mechanism 16 employed in this embodiment.

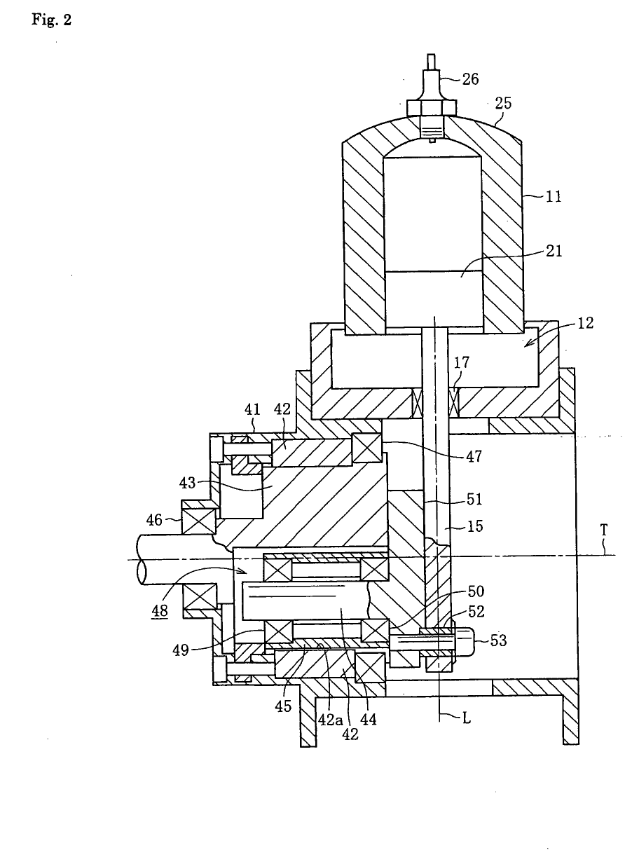

As shown in FIG. 2, the crank mechanism 16 is provided with a crankcase 41, an inner peripheral sun gear 42, a crank shaft 43, a planet shaft 44, and a planet gear 45.

The crankcase 41 contains each of the components of the crank mechanism 16, and engine oil is stored in the crankcase 41 to ensure lubrication of each of the components of the crank mechanism 16. In this embodiment, the crankcase 41 contains the lower end of the connecting rod 15 which extends through the scavenging gas reserving chamber 12.

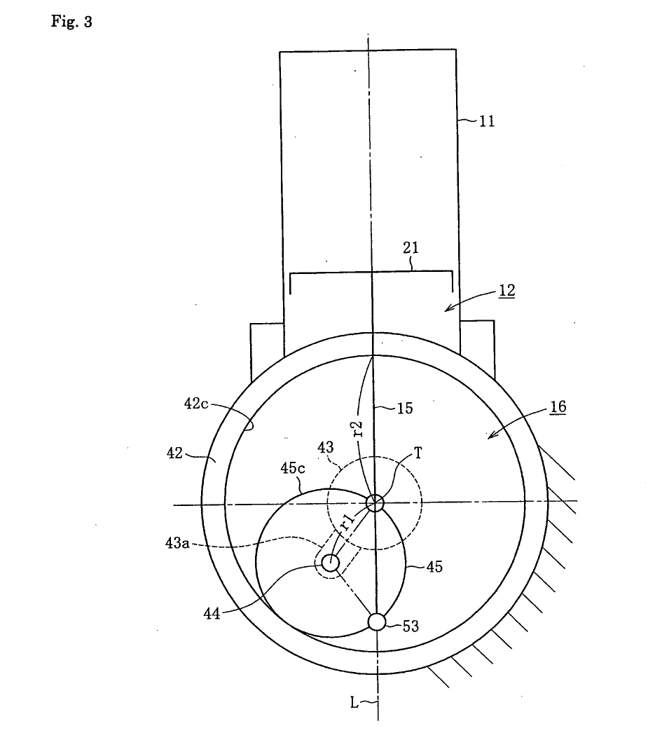

As shown in FIG. 3, the inner peripheral sun gear 42 is fixedly disposed on the crankcase 41 such that a central axis T of the pitch circle of the sun gear 42 is orthogonal to an axis line L extending along the connecting rod 15 and so as to be parallel to the axis line L.

The crank shaft 43 is rotatably disposed about the central axis of the pitch circle of the inner peripheral sun gear 42 and has an arm portion which projects in the radial direction from the crank shaft 43 and which rotatably supports the rotation axis of the planet gear 45.

In this embodiment, the crank shaft 43 is rotatably contained in the crankcase 41 through bearings 46 and 47 with the rotation axis of the crank shaft 43 coinciding with the central axis T of the crank mechanism 16. The crank shaft 43 is not in contact with an inner peripheral tooth surface 42a of the inner peripheral sun gear 42. A containing space 48 is provided at a position eccentric from the crank shaft 43 to contain the planet shaft 44 serving as the rotation axis of the planet gear 45. That is, in this embodiment, the containing space 48 corresponds to the arm portion 43a projecting in the radial direction from the crank shaft 43 in FIG. 3.

Bearings 49 and 50 are disposed in the containing space 48 to pivotally support the planet shaft 44. The position at which the crank shaft 43 pivotally supports the planet shaft 44 is a position eccentric from the center of the crank shaft 43 (the center of the pitch circle of the inner peripheral sun gear 42) by a distance which is half a radius r2 of the pitch circle of the inner peripheral sun gear 42.

The planet gear 45 is pivotally supported by the crank shaft 43 as described above and has a pitch circle diameter which is half the pitch circle diameter of the inner peripheral sun gear 42. Furthermore, the planet gear 45 is disposed such that the rotation and revolution thereof are allowed during meshing. Moreover, the connecting rod 15 is engaged through a pin on the circumference of the pitch circle of the planet gear 45.

In this embodiment, a counterbalancer 51 is provided in a side surface of the planet shaft 44 on the connecting rod 15 side, as shown in FIG. 2. In a side surface of the counterbalancer 51, a crank pin 53 of the connecting rod 15 is connected through a bearing 52 to a position corresponding to the revolution of a pitch circle 45c of the planet gear 45 and the axis line L extending along the connecting rod 15.

In the crank mechanism 16, the ratio between a radius r1 of the pitch circle 45c of the planet gear 45 and a radius r2 of a pitch circle 42c of the inner peripheral sun gear 42 is r1:r2=1:2, as shown in FIG. 3. Hence, the planet gear 45 revolves and rotates while meshing with the inner peripheral sun gear 42 and thus rotates twice for every revolution thereof. Furthermore, upon the revolution of the planet shaft 44, the crank shaft 43 rotates with a period equal to that of the linear reciprocating movement of the crank pin 53. Thus, the crank mechanism 16 allows the connecting rod 15 to reciprocate linearly while being maintained vertically, and the distance of the linear reciprocating movement of the connecting rod 15 corresponds to the diameter of the pitch circle of the inner peripheral sun gear 42. Therefore, in this crank mechanism 16, the size of each part such as the inner peripheral sun gear 42 and the planet gear 45 is designed according to the distance of the reciprocating movement of the piston 21 in the two cycle engine 10A.

According to this crank mechanism 16, the connecting rod 15 reciprocates linearly. Thus, in the structure of. the two cycle engine 10A described above, the connecting rod 15 hardly swings and moves in the insertion hole 35 for the connecting rod 15 passing through the scavenging gas reserving chamber 12. Therefore, the scavenging gas reserving chamber 12 can be easily sealed, for example, by use of a rubber-made sealing material or the like, and the crank mechanism 16 is suitably employed in the two cycle engine 10A described above. Furthermore, according to this crank mechanism 16, the connecting rod 15 reciprocates linearly. Thus, a loss due to the side thrust of the piston 21 is small, and thus the energy efficiency of the two cycle engine 10A can be improved.

In the above, the structure of the two cycle engine 10A according to the embodiment of the present invention has been described.

In this two cycle engine 10A, at a predetermined timing when the piston 21 reaches the top dead center and a gas mixture of fuel and air is compressed, the spark plug 26 generates a spark to combust (explode) the gas mixture. Upon burning (explosion) of the gas mixture, the piston 21 moves down. Then, when the exhaust port 23 is opened, the combusted gas is discharged from the exhaust port 23, and the pressure inside the cylinder 11 is reduced. Subsequently, when the scavenging port 24 is opened, the scavenging gas, which has been compressed by the downward movement of the piston 21 in the scavenging gas reserving chamber 12, flows from the scavenging port 24 into the cylinder 11 through the scavenging passage 14. Furthermore, while the piston 21 moves down and up again, the scavenging gas flows into the cylinder 11, and the exhaust gas is discharged from the exhaust port 23. During the process in which the piston 21 moves up, the scavenging port 24 and the exhaust port 23 are closed in that order. Hence, gas in the cylinder 11 is replaced with the scavenging gas, and the scavenging gas is compressed. At the timing when the piston 21 reaches the top dead center, the spark plug generates a spark. In this two cycle engine 10A, such a series of strokes is repeated to linearly reciprocate the piston 21, whereby rotational power is obtained from the crank shaft 43 through the connecting rod 15 and the crank mechanism 16.

In this two cycle engine 10A, since the scavenging gas reserving chamber 12 is separated from the crankcase 41 containing the crank mechanism 16 by the sealing portion 17, the engine oil supplied to the crank mechanism 16 does not flow into the scavenging gas reserving chamber 12. Therefore, a fluid flowing from the scavenging port 24 into the cylinder 11 through the scavenging passage 14 does not contain the engine oil, and thus a decrease in the amount of the engine oil in the crank mechanism 16 can be suppressed, and thus it is economical. Furthermore, since the engine oil is not combusted with fuel, white smoke and soot caused by the engine oil are not generated. As described above, the two cycle engine 10A is a novel two cycle engine which is excellent in economical efficiency and is environmentally friendly.

In the above, a description has been given of the two cycle engine according to the embodiment of the present invention. However, the two cycle engine according to the present invention is not limited to the embodiment.

For example, the crank mechanism is not limited to the mechanism according to the foregoing embodiment, so long as the connecting rod is allowed to reciprocate linearly. In place of the crank mechanism 16 according to the foregoing embodiment, a known crank mechanism which exerts such an action can be employed.

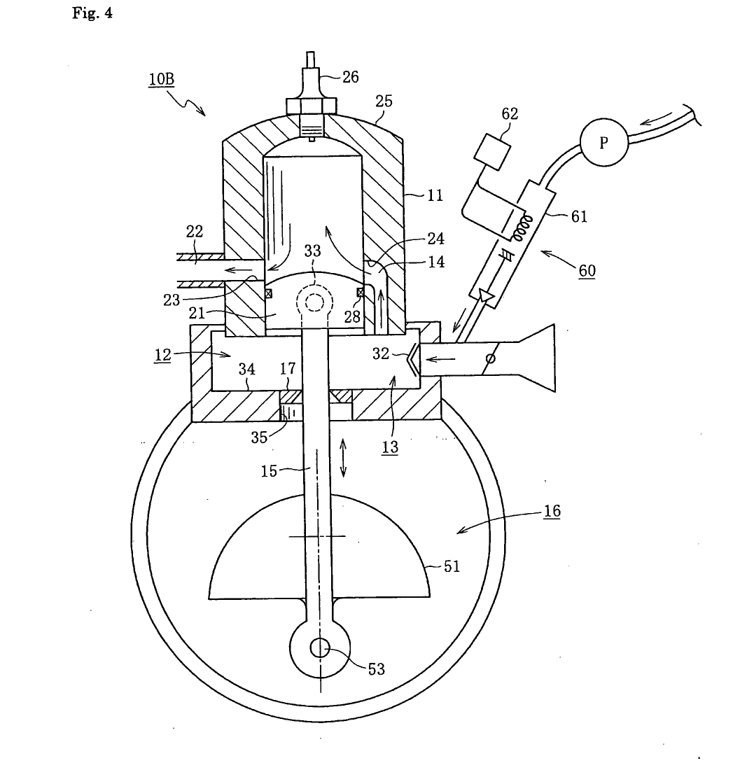

As another embodiment, a two cycle engine 10B may have a structure in which the intake portion 13 thereof is provided with a piezo injector 61 and a control device 62 for controlling a spraying operation of the piezo injector 61 as shown in FIG. 4. In this case, fuel is sprayed by the piezo injector 61 to form a gas mixture by mixing with outside air, and the gas mixture is drawn into the scavenging gas reserving chamber 12 at an appropriate time. As compared to the case of the carburetor 31 (see FIG. 1), the device structure of the piezo injector 61 can be miniaturized, and the spray amount of fuel can be finely controlled by the piezo injector 61. Thus, the two cycle engine 10B can be miniaturized. The piezo injector 61 can be suitably applied to the small two cycle engine 10B and the like employed in lawn mowers and the like.

In a two cycle engine 10C according to another embodiment, the intake portion 13 may be provided with a structure for drawing outside air into the scavenging gas reserving chamber 12, and a spraying mechanism 60 for spraying fuel may be provided in the cylinder head 25.

Specifically, in this two cycle engine 10C, fuel may be sprayed from the spraying mechanism 60, for example, after the piston 21 is moved up to close the exhaust port 23. In this case, since the scavenging gas does not contain the fuel, the problem of discharging the fuel from the exhaust port 23 without being combusted can be prevented. Furthermore, the fuel supplied into the cylinder 11 can be easily controlled, and thus the output power of the two cycle engine 10C can be adjusted with high responsiveness. Therefore, a control device for controlling the spraying amount and spraying timing of the fuel may be provided in the spraying mechanism 60.

Also in the two cycle engine 10C of this embodiment, the spraying mechanism 60 may also have a structure provided with a piezo injector 61 in which a piezo element is employed and a control device 62 for controlling a spraying operation of the piezo injector 61 as shown in the figure. In this manner, the two cycle engine 10C can be miniaturized, and the timing for supplying the fuel to the cylinder 11 and the supply amount of the fuel can be finely adjusted. A spraying mechanism 60 of other type may be employed in which a solenoid, a mechanical plunger, or the like is employed in place of the piezo injector 61.

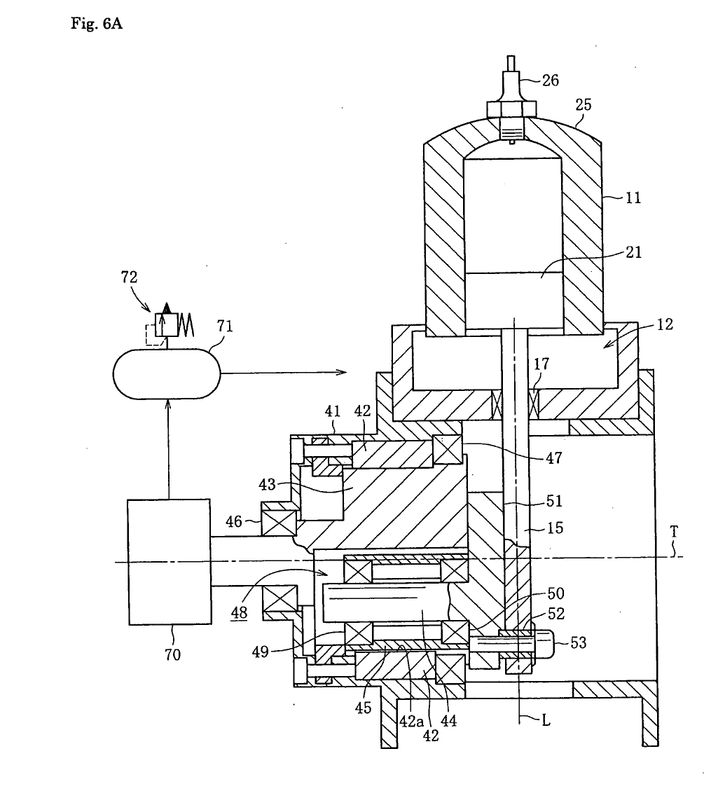

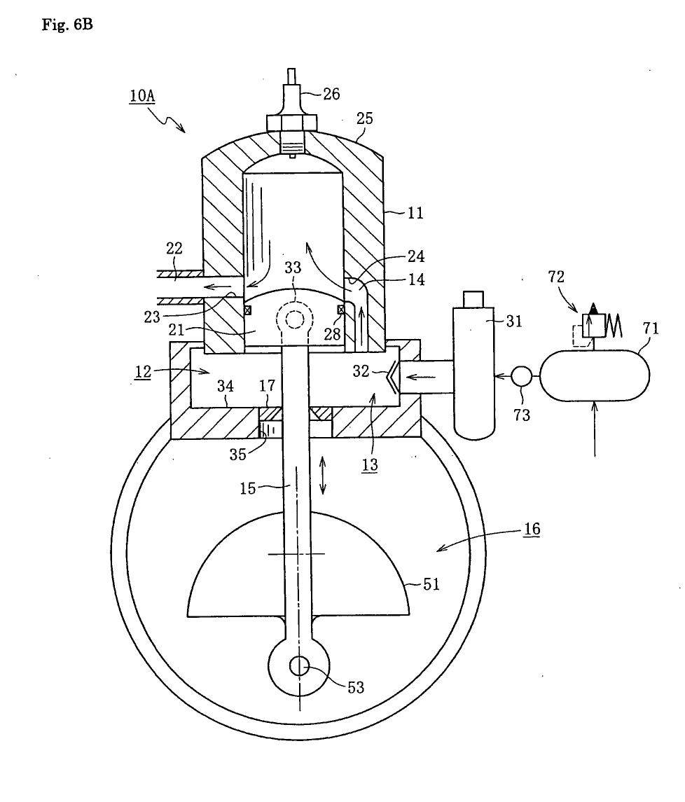

Next, with reference to FIGS. 6A and 6B, a description is given of an embodiment in which a supercharging device is mounted on the two cycle engine of the present invention. In this embodiment, an air compressor 70 serving as the supercharging device is mounted in the crank shaft 43 extending outward from the bearing 46, as shown in FIGS. 6A and 6B. The air compressor 70 is driven by the rotational force of the crank shaft 43. In the illustrated example, the air compressor 70 is directly connected to the crank shaft 43, but a transmission of a gear type, a belt type, or a CVT type may be combined in accordance with need. An air outlet of the air compressor 70 is connected to an air reservoir 71. The air reservoir 71 has a relief valve 72 and stores the compressed air obtained by the air compressor 70 at a constant pressure. As shown in FIG. 6B, the air reservoir 71 is connected to an intake port of the carburetor 31 through an air injection valve 73. The air injection valve 73 is designed so as to momentarily open in accordance with a predetermined timing during the vertical movement of the piston 21. When the air injection valve 73 is opened, a gas mixture mixed with fuel fills the scavenging gas reserving chamber 12 at a predetermined high pressure. Hence, the gas mixture having a pressure equal to or higher than atmospheric pressure is introduced into the cylinder 11 at a predetermined timing during the vertical movement of the piston 21, whereby the supercharging effect is obtained. In the two cycle engine of the present invention, the connecting rod reciprocates linearly, and thus the stroke length and the compression ratio can be easily increased. Therefore, by combining the supercharging device with the two cycle engine, for example, biomass fuel (such as methanol, ethanol, and methane gas) having a high octane value can be combusted efficiently.

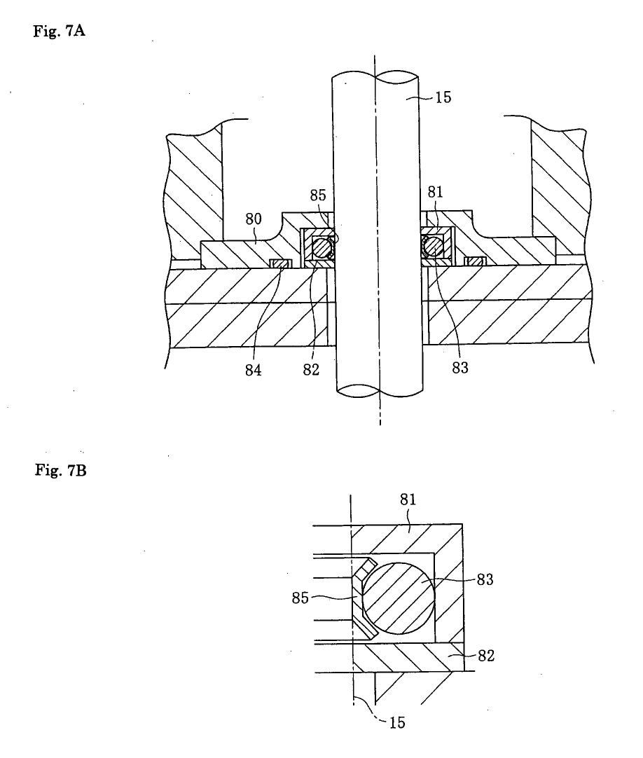

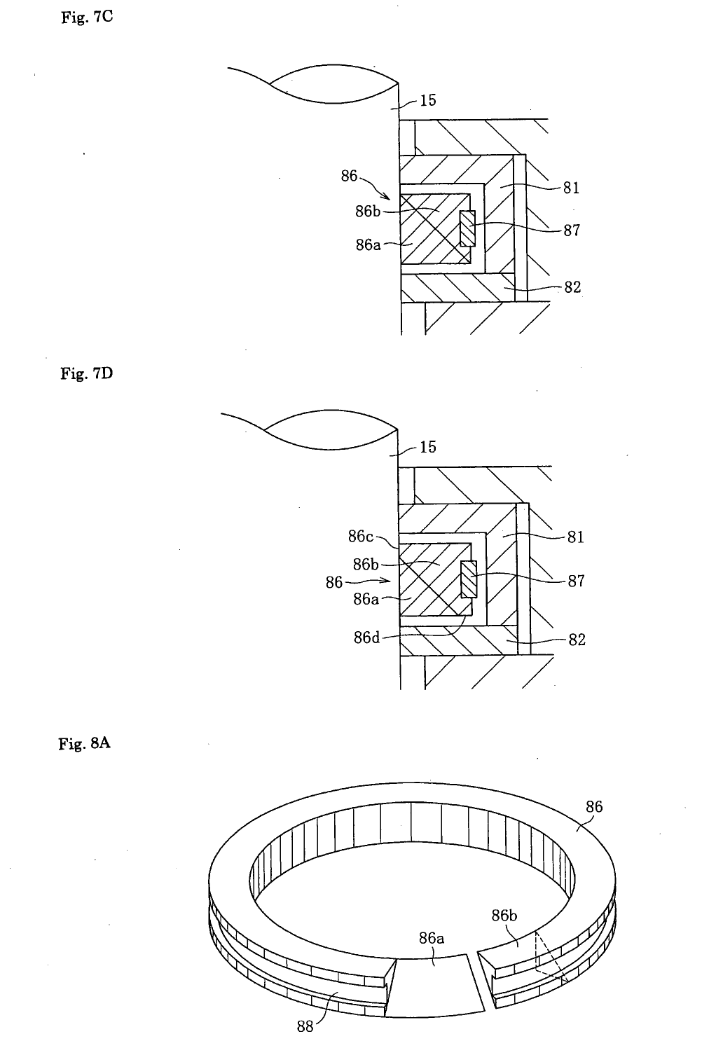

Next, with reference to FIGS. 7A and 7B, a description is given of a modified example of the sealing mechanism disposed between the crankcase and the scavenging gas reserving chamber 12. In FIGS. 7A and 7B, reference numeral 80 represents a sealing holder, reference numeral 81 represents a sealing slide cup, reference numeral 82 represents a sealing slide washer, and reference numerals 83 and 84 represent an O-ring. Furthermore, reference numeral 85 represents a rod sealing ring. The sealing holder 80 is fixed with a bolt or the like to a housing, through which the connecting rod 15 passes, so as to surround a hole through which the connecting rod passes. A gap is formed between the inner diameter portion of the sealing holder 80 and the connecting rod 15. The sealing slide cup 81 and the sealing slide washer 82 are disposed vertically inside the sealing holder 80. The O-ring 83 is contained between the sealing slide cup 81 and the sealing slide washer 82.

The sealing slide cup 81, the sealing slide washer 82, and the rod sealing ring 85 are made of Teflon (“Teflon” is a registered trademark of DuPont U.S.), and the inner diameter portions thereof are slidingly in contact with the outer peripheral surface of the connecting rod 15. The sealing slide cup 81 and the sealing slide washer 82 can be displaced independently within the sealing holder 80 in a radial direction. The rod sealing ring 85 is formed into a C-shaped ring having a portion which is opened along the circumferential direction and having a cross-section in which both the side edges thereof are inclined obliquely outwardly. The O-ring 83 is fitted to the outer peripheral surface of the rod sealing ring 85. The O-ring 83 is made of rubber and presses the outer peripheral surface of the rod sealing ring 85 with an adequate tightening force. The O-ring 83 and the rod sealing ring 85 are moved vertically by a slight stroke between the sealing slide cup 81 and the sealing slide washer 82 in accordance with the vertical movement of the connecting rod 15. The other O-ring 84 is disposed between the sealing holder 80 and the housing to maintain the hermeticity of the locating surface of the sealing holder 80.

As described above, the sealing slide cup 81, the O-ring 83, the sealing slide washer 82, and the rod sealing ring 85 are disposed between the crankcase and the scavenging gas reserving chamber 12. Thus, when the connecting rod 15 moves vertically while being inclined at a very small angle because of backlash or the like between the inner peripheral sun gear 42 and the planet gear 45, the movement of the sealing slide cup 81, the O-ring 83, the sealing slide washer 82, and the rod sealing ring 85 follows the inclination and radial displacement of the connecting rod 15, whereby good sealing action is maintained. Hence, the pressure in the scavenging gas reserving chamber 12 is maintained, and the oil in the crankcase is prevented from entering the scavenging gas reserving chamber 12.

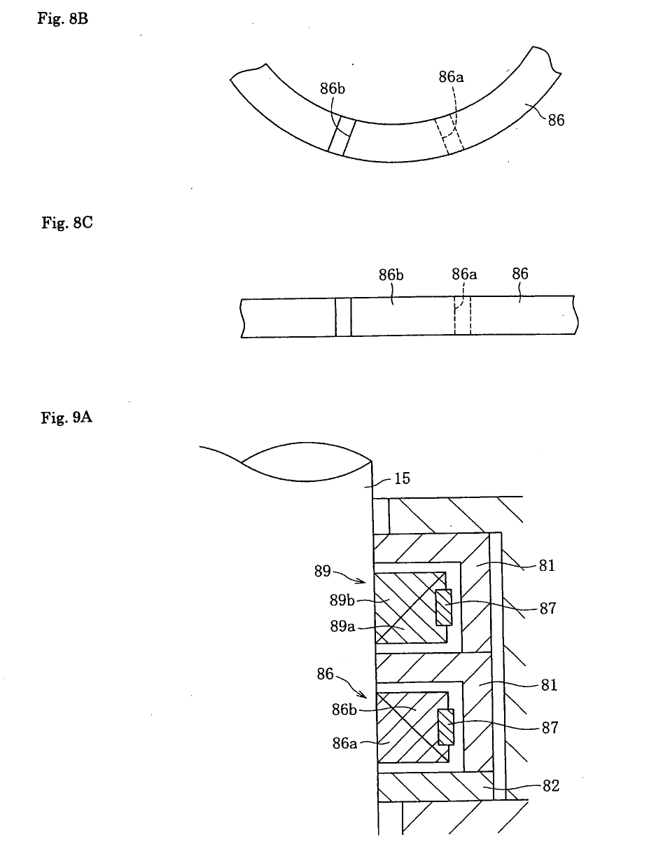

With reference to FIG. 7C, a description is given of another modified example of the sealing mechanism disposed between the crankcase and the scavenging gas reserving chamber 12. In this modified example, a rod sealing ring 86 and a snap ring 87 are provided in place of the combination of the O-ring 83 and the rod sealing ring 85. The sealing slide cup 81 and the sealing slide washer 82 are the same as those shown in FIGS. 7A and 7B. The rod sealing ring 86 is made of Teflon or metal and has a shape shown as in FIGS. 8A to 8C. The rod sealing ring 86 is a C-shaped ring having a portion which is opened along the circumferential direction, and the major portion thereof except two opening ends 86a and 86b has basically a rectangular cross-section. However, in a natural state of the rod sealing ring 86, the opening ends 86a and 86b overlap one another.

A shallow circumferential groove 88 to which the planar ring-like snap ring 87 can be fitted is formed in the outer peripheral surface of the rod sealing ring 86. The cross-sections of the two opening ends 86a and 86b of the rod sealing ring 86 are molded into right triangles which are complementary to each other. Specifically, when the two opening ends 86a and 86b are overlapped, the cross-section thereof becomes rectangular as shown in FIG. 7C. Such an overlapped structure is employed for preventing reduction in sealing properties in the portion at which the ring is opened.

In the rod sealing ring 86, the two opening ends 86a and 86b tend to be brought into proximity to each other and to be overlaid with each other through the elastic restoring force of the rod sealing ring 86 and the elastic diameter reducing force of the snap ring 87. Due to the force in the diameter reducing direction, the inner diameter surface of the rod sealing ring 86 is brought into intimate contact with the connecting rod 15. When the sealing mechanism by means of the rod sealing ring 86, the sealing properties on the outer peripheral surface of the connecting rod 15 are enhanced by the surface contact of the rod sealing ring 86. Therefore, oil throwing and prevention of air leakage between the scavenging gas reserving chamber 12 and the crankcase are further ensured.

FIG. 7D shows still another modified example of the rod sealing ring 86. In this modified example, the cross-sectional shapes of the two opening ends 86a and 86b are different from those in FIG. 7C. That is, the cross-section of the outer opening end 86b is larger than the cross-section of the inner opening end 86a. Hence, planer portions 86c and 86d are formed in respective corner portions of the outer opening end 86b, and the planar portion 86c is in contact with the peripheral surface of the connecting rod 15. The other planar portion 86d abuts on the sealing slide washer 82.

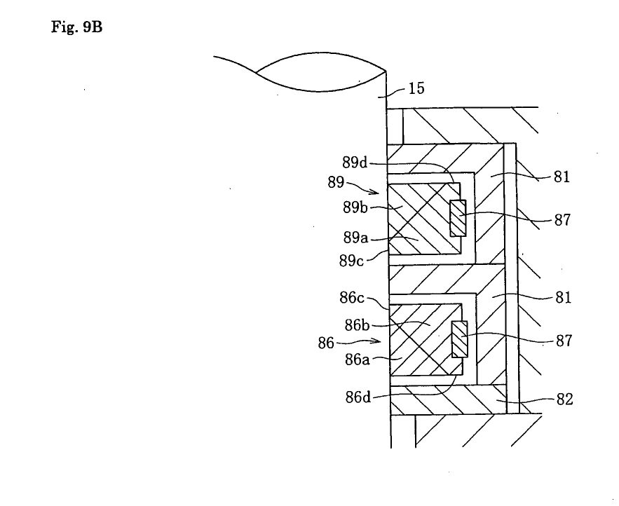

With reference to FIG. 9A, a description is given of yet another modified example of the sealing mechanism disposed between the crankcase and the scavenging gas reserving chamber 12. This modified example is of a double ring type in which two rod sealing rings are vertically disposed. Specifically, the rod sealing ring 86 described above is disposed in a lower portion, and a rod sealing ring 89 of an inversion type is disposed in an upper portion. As used herein, the “inversion type” refers to that two opening ends 89a and 89b of the rod sealing ring 89 have respective cross-sectional shapes which are vertical inversions of the cross-sectional shapes of the two opening ends 86b and 86a of the rod sealing ring 86 in the lower portion. The other portions are the same as those of the rod sealing ring 86 in the lower portion. Furthermore, another sealing slide cup 81 is added for the upper rod sealing ring 89. The sealing mechanism of FIG. 9A provides good sealing properties on both pressure from the scavenging gas reserving chamber 12 and pressure from the crankcase. Specifically, when the pressure from the upper side in FIG. 9A (the scavenging gas reserving chamber 12) is higher, the opening end 89b of the rod sealing ring 89 is pressed inward through the taper action of the inclined surface of the cross-section of the opening end 89b. Furthermore, when the pressure from the lower side (the crankcase) is higher, the opening end 86a of the rod sealing ring 86 is pressed inward through the taper action of the inclined surface of the cross-section of the opening end 86a. Hence, good sealing properties on both the pressures from the upper and lower sides can be provided.

With reference to FIG. 9B, a description is given of still another modified example of the sealing mechanism. In this modified example, as in FIG. 7D, the cross-section of the outer opening ends 86b and 89a of the rod sealing rings 86 and 89 is larger than the cross-section of the inner opening ends 86a and 89b, respectively. Hence, planer portions 86c, 86d, 89c, and 89d are formed in respective corner portions of the outer opening ends 86b and 89a. The planar portions 86c and 89c contact the peripheral surface of the connecting rod 15. The other planar portions 86d and 89d abut on the sealing slide washer 82 and the sealing slide cup 81, respectively.

The characteristics of the sealing mechanisms of FIGS. 7C to 9B are itemized as follows:

1. A sealing mechanism, comprising a rod sealing ring slidably attached to an outer peripheral surface of a rod, the rod sealing ring having: an elastic C-shaped ring body which has a rectangular cross-section; and two opening ends which are located in respective two end portions of the abovementioned ring body and have right triangular cross-sections which are complementary to each other.

2. A sealing mechanism, comprising a plurality of the abovementioned rod sealing rings slidably attached to the outer peripheral surface of the rod.

3. A sealing mechanism, wherein a snap ring is fitted to an outer peripheral surface of the abovementioned rod sealing ring.

4. A sealing mechanism, comprising the abovementioned rod sealing rings in two stages, slidably attached to the outer peripheral surface of the rod, wherein inclined surfaces, at which one opening ends of the respective rod sealing rings abut on the other opening ends of the respective rod sealing rings, extend so as to open away from each other outwardly in a radial direction of the rod.

5. A sealing mechanism, comprising a rod sealing ring slidably attached to an outer peripheral surface of a rod, the rod sealing ring having: an elastic C-shaped ring body which has a rectangular cross-section; and two opening ends located in respective end portions of the abovementioned ring body, one of the opening ends being located more inward than the other opening end, the other opening end having a cross-sectional shape complementary to the abovementioned right triangle and having two planar portions.

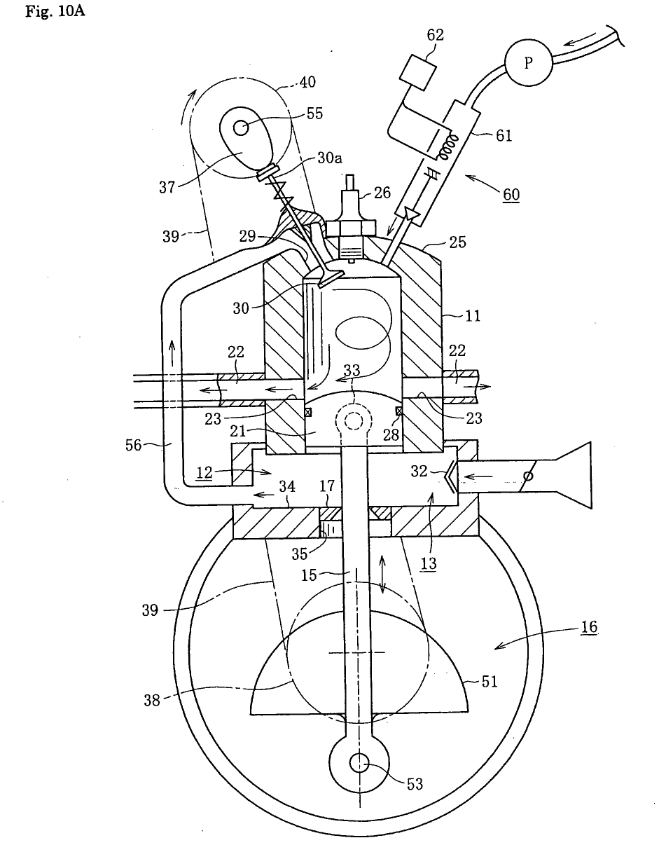

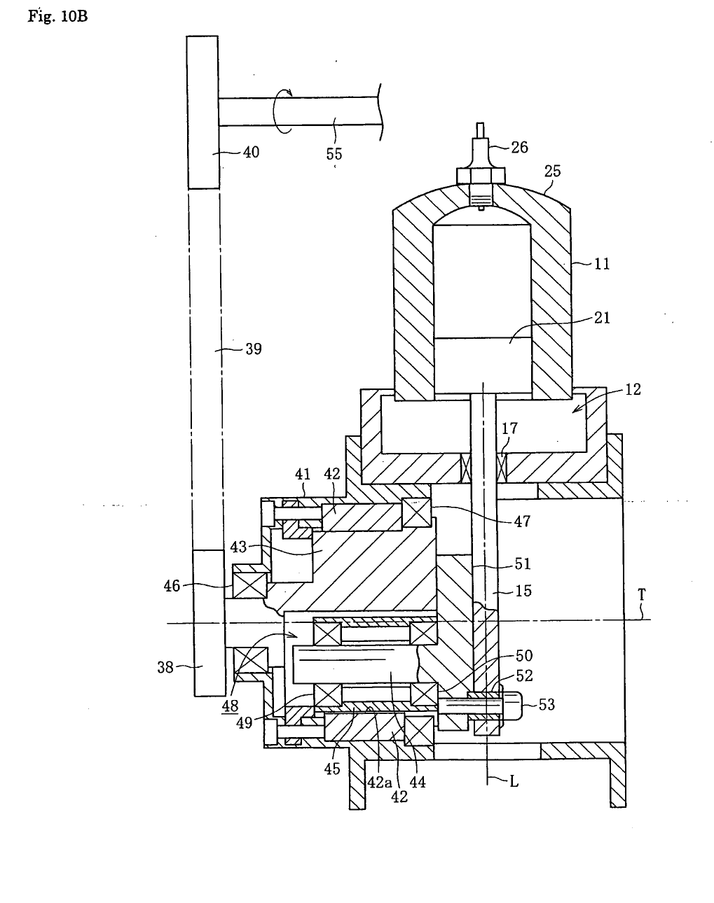

Next, with reference to FIGS. 10A and 10B, a description is given of a two cycle engine according to another embodiment of the present invention. This embodiment is referred to as a so-called uniflow type. The exhaust port 23 is provided in part of the lower portion of the cylinder 11 or in a plurality of positions along the circumferential direction of the cylinder 11, and a scavenging port 29 is provided in the upper portion of the cylinder 11, i.e., in the cylinder head 25. The scavenging port 29 and the scavenging gas reserving chamber 12 are connected through a connection pipe 56.

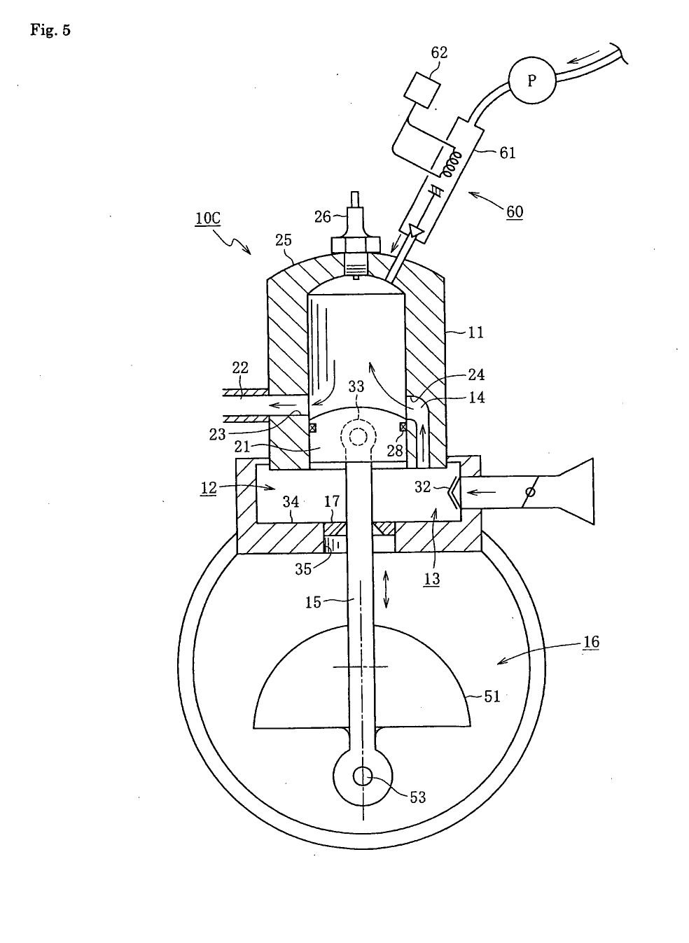

The scavenging port 29 is opened and closed through a valve 30. The valve 30 is always urged in a direction of closing the valve through the force of a spring. The peripheral surface of a cam 37 abuts on the end of a stem 30a of the valve 30. As shown in FIG. 10B, the rotational force of the cam 37 is transmitted from the crank shaft 43 through a first pulley 38, a timing belt 39, a second pulley 40, and a cam shaft 55. The other portions are the same as in FIG. 5.

As described above, by providing the scavenging port 29 in the cylinder head 25, the exhaust gas in the cylinder 11 flows in one direction from the upper portion to the lower portion, whereby the scavenging efficiency is significantly improved. Furthermore, since the exhaust port 23 can be formed in a plurality of positions over the entire periphery of the lower portion of the cylinder 11, the exhaust resistance of the exhaust passage 22 can be reduced as much as possible. Moreover, by changing the shape of the scavenging port 29 and the valve 30, the flow of a fuel-air gas mixture flowing from the scavenging port 29 can be optimized to form, for example, a spiral flow having high scavenging efficiency.

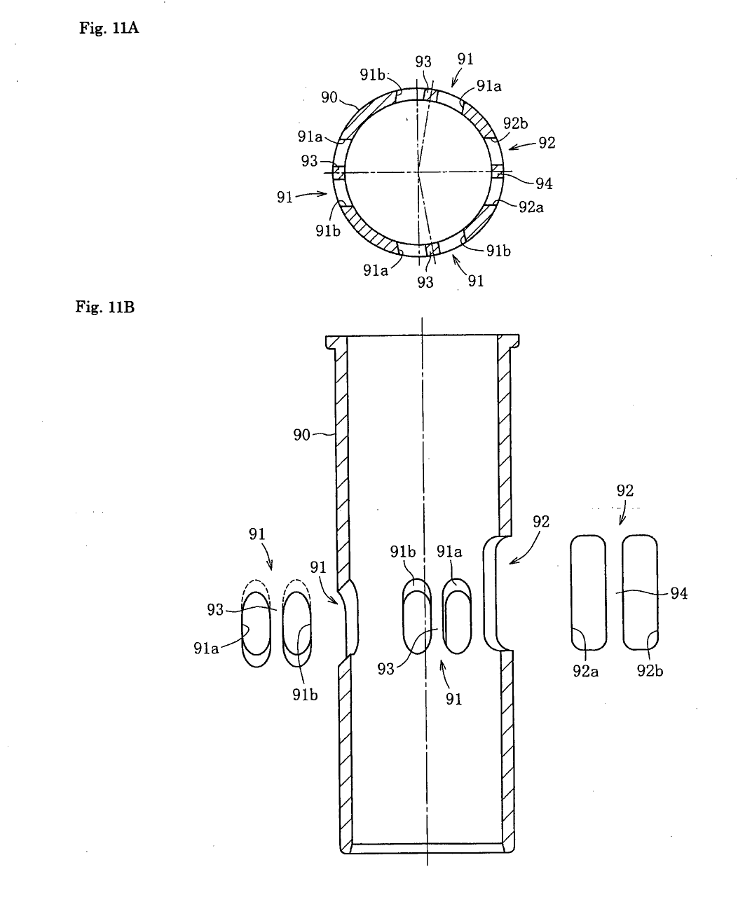

Next, with reference to FIGS. 11A and 11B, a description is given of a cylinder liner 90. This cylinder liner 90 is fitted to the inner peripheral surface of the cylinder 11 shown in FIG. 1, and the piston 21 is inserted inside the cylinder liner 90. Scavenging ports 91 and an exhaust port 92 are formed in the cylinder liner 90. As shown in FIG. 11A, the scavenging ports 91 occupy three positions among four quadrants along the circumferential direction of the cylinder liner. Each of the scavenging ports 91 is constituted by a pair of left and right ports 91a and 91b, and a reinforcing rib 93 is formed between the left and right ports 91a and 91b.

The exhaust port 92 is located in a position in the rest of the quadrants along the circumferential direction of the cylinder liner. The exhaust port 92 is also constituted by a pair of left and right ports 92a and 92b, and a reinforcing rib 94 extending in the vertical direction is formed between the left and right ports 92a and 92b. Hence, by forming the reinforcing ribs 93 and 94 between the left and right ports, the strength of the scavenging ports 91 and the exhaust port 92 is enhanced. Particularly, since the exhaust port 92 is exposed to high temperature exhaust gas, the reinforcing rib 94 plays an important role.

Furthermore, the reinforcing ribs 93 and 94 extending in the vertical direction allow a piston ring 28 (see FIGS. 1, 4, and 5) attached to the piston 21 to smoothly pass through both the ports 91 and 92 without being caught by the scavenging ports 91 and the exhaust port 92 during the vertical stroke of the piston 21.

Normally, the piston ring 28 is made of steel, but the piston ring 28 made of resin is employed in the two cycle engine of the present invention. The piston ring 28 made of resin has self-lubricating properties and thus can prevent seizing even in oil-free fuel not mixed with lubricating oil. Teflon graphite is suitable for such a resin material, and the seizing resistance is further improved by mixing zinc particles serving as a filler material with the Teflon graphite. The piston ring 28 may be formed of a resin material other than Teflon. Examples of such a resin material which may be used include resins having high-pressure resistance, high sliding performance, and wear resistance such as polyimide resins (PI), polyimide resins with which a filler material is mixed, polyether ether ketone resins (PEEK), and polyether ether ketone resins with which a filler material is mixed.

The cylinder liner 90 shown in FIGS. 11A and 11B is not applicable to a two cycle engine of the type in which the cylinder head 25 has the scavenging port 29 as shown in FIGS. 10A and 10B. For a two cycle engine of such a uniflow type, the scavenging ports 91 of the cylinder liner 90 are not provided, and only the exhaust port 92 is provided.

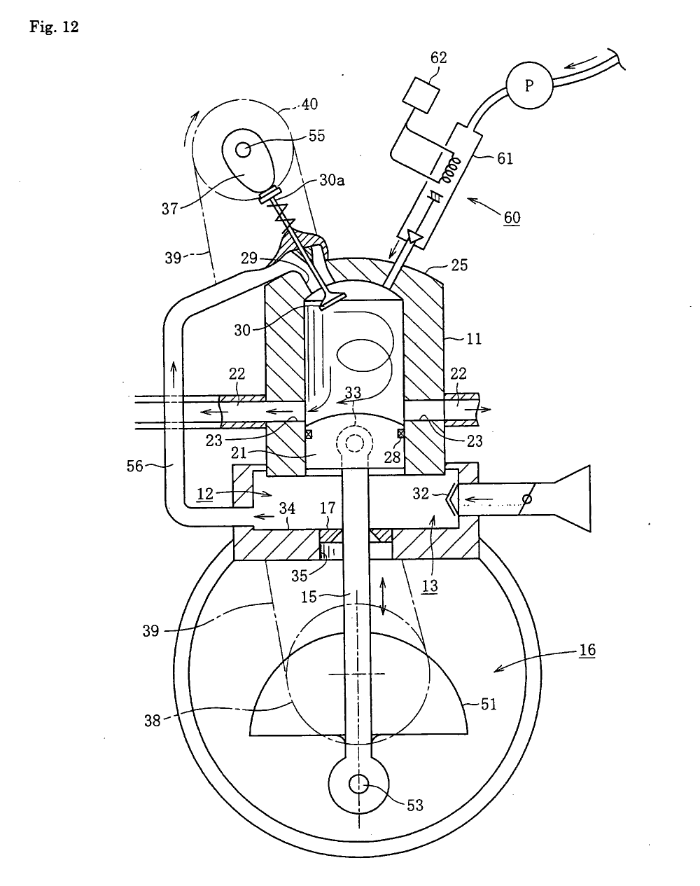

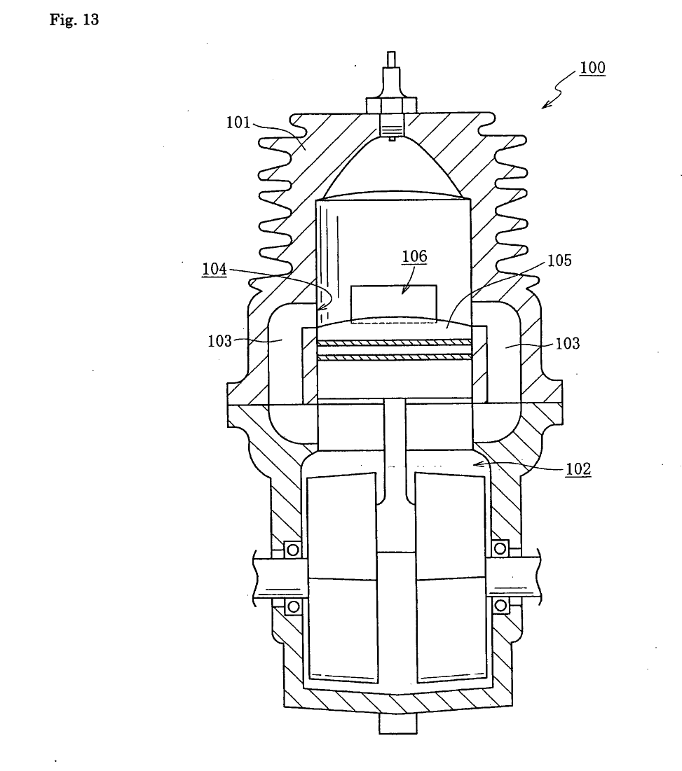

Next, FIG. 12 shows a two cycle diesel engine according to an embodiment of the present invention. This two cycle diesel engine is constituted by removing the spark plug 26 from the engine shown in FIG. 10A. The other parts are the same as those in FIGS. 5 to 10A. In this two cycle diesel engine, the long stroke characteristics of the present invention are utilized. Specifically, air drawn from the scavenging port 29 into the cylinder 11 is highly compressed, and light oil, serving as fuel, injected from the spraying mechanism 60 is self ignited.

What is claimed is:

1. A two cycle engine comprising:
a cylinder which contains a piston so as to allow reciprocating movement of the piston;
a scavenging gas reserving chamber which covers a lower opening of the cylinder so as to seal the lower opening;
an intake portion which is provided in the scavenging gas reserving chamber;
a scavenging passage which provides communication between the scavenging gas reserving chamber and the cylinder;
a connecting rod which is connected to the piston and passes through the scavenging gas reserving chamber;
a crank mechanism for linearly reciprocating the connecting rod; and
a sealing portion which is provided in an insertion hole in the scavenging gas reserving chamber through which the connecting rod passes, the sealing portion allowing linear reciprocating movement of the connecting rod but sealing the scavenging gas reserving chamber.

2. A two cycle engine according to claim 1, wherein the intake portion includes a piezo injector and a control device for controlling a spraying operation of the piezo injector, and wherein a gas mixture of fuel and outside air formed by spraying the fuel by means of the piezo injector is drawn into the scavenging gas reserving chamber at an appropriate time.

3. A two cycle engine according to claim 1, wherein the intake portion has a structure for drawing outside air into the scavenging gas reserving chamber, and wherein a spraying mechanism for spraying fuel is provided in a cylinder head.

4. A two cycle engine according to claim 3, wherein the spraying mechanism includes a piezo injector and a control device for controlling a spraying operation of the piezo injector.

5. A two cycle engine according to claim 2, wherein the crank mechanism has: an inner peripheral sun gear in which a central axis of a pitch circle thereof is orthogonal to an axis line extending along the connecting rod and which is fixedly disposed in parallel to the axis line extending along the connecting rod; a planet gear which has a pitch circle diameter half a pitch circle diameter of the inner peripheral sun gear and which is disposed such that rotation and revolution thereof are allowed during meshing; a crank shaft disposed rotatably about the central axis of the pitch circle of the inner peripheral sun gear; and an arm portion which projects in a radial direction of the crank shaft and rotatably supports a rotation axis of the planet gear, wherein the connecting rod is engaged through a pin on a circumference of the pitch circle of the planet gear

6. A two cycle engine according to claim 1, wherein a supercharging device is connected to the scavenging gas reserving chamber.

7. A two cycle engine according to claim 1, wherein a sealing member hermetically separating the scavenging gas reserving chamber from a crankcase is disposed around the connecting rod passing through the scavenging gas reserving chamber so as to be displaceable in a redial direction.

8. A two cycle engine according to claim 1, wherein a cylinder liner is fitted to an inner periphery of the cylinder, wherein at least an exhaust port of the cylinder liner is composed of a pair of left and right exhaust ports, and wherein a reinforcing rib is formed between the left and right exhaust ports.

9. A two cycle diesel engine having a structure of claim 1.
